(19) United States
(12) Patent Application Publication
(10) Pub. No.: US 2005/0246087 A1
(43) Pub. Date: Nov. 3, 2005

(54) Device, method, and car for estimating variation of state of road surface

(76) Inventors: Akira Hommi, Nishikamo-gun (JP); Kiyotaka Hamajima, Okazaki-shi (JP); Mitsuhiro Nada, Toyota-shi (JP)

Correspondence Address: KENYON & KENYON, 1500 K STREET NW, SUITE 700, WASHINGTON, DC, 20005, US

(21) Appl. No.: 10/525,871

(22) PCT Filed: Jun. 23, 2003
(86) PCT No.: PCT/JP03/07919

§ 371 Date: Feb. 25, 2005

(30) Foreign Application Priority Data
Aug. 29, 2002 (JP) 2002-251361

(51) Int. Cl. G06F 7/00

(52) U.S. Cl. 701/80; 701/72

(57) ABSTRACT

The control procedure of the invention sets the measured value of the rotation angular acceleration α to a first peak angular acceleration α1 at a timing when the rotation angular acceleration α of a motor, which directly outputs torque to a drive shaft, reaches a first peak after an increase over a preset threshold value αslip that suggests the occurrence of a wheelspin-induced skid. The control procedure also sets a second peak angular acceleration α2 by multiplication of the measured value of the rotation angular acceleration α by ‘−1’ at a timing when the rotation angular acceleration α reaches a negative second peak detected immediately after the first peak. A change of a road surface condition (for example, a shift from a low μ road surface to a high μ road surface) is estimated when the second peak angular acceleration α2 is not less than a preset reference value αref or when the second peak angular acceleration α2 is less than the preset reference value αref but is greater than the product of the first peak angular acceleration α1 and a constant k. The output torque level from the motor to the drive shaft is restricted for a preset time period, in response to estimation of the change of the road surface condition.

### TECHNICAL FIELD

The present invention relates to a road surface condition change estimation apparatus that estimates a change in condition of a road surface where an automobile runs, an automobile with such apparatus, and a corresponding road surface condition change estimation method.

### BACKGROUND ART

Diversity of apparatuses have been proposed to estimate a change of a road surface condition in the vehicle driving state. One proposed apparatus estimates a variation in friction coefficient on the road surface, based on a vibration component of a measured wheel speed in response to a pulse-like change of brake hydraulic pressure in the braking state (see, for example, Japanese Patent Laid-Open Gazette No. 2000-313327). In an apparatus that estimate a braking torque gradient in the vehicle braking state, computes a difference between the estimated braking torque gradient and a target value, and executes control to cancel out the computed difference, a proposed technique estimates a variation in friction coefficient on the road surface when the difference of or over a preset level continues for a predetermined time period (see, for example, Japanese Patent Laid-Open Gazette No. 11-321617). Another proposed apparatus detects a rough road surface or a vibration in a driving system based on a difference between the speed of drive wheels and the speed of driven wheels (see, for example, Japanese Patent Laid-Open Gazette No. 11-38034).

In an automobile having the ability of handling a skid or a rock based on the road surface conditions and the driving conditions, one proposed technique detects a skid or a rock and prohibits a change of the torque level output to the drive shaft until convergence of the skid or the rock (see, for example, Japanese Patent Laid-Open Gazette No. 7-143618).

The estimation result of a change of the road surface condition in the vehicle driving state is applicable to the control technique of preventing the wheelspin of the drive wheels or the rock of the drive wheels or the driven wheels, which may occur with the change of the road surface condition. This desirably enhances the driving stability. Development of a novel estimation technique having the higher accuracy is thus highly demanded.

### DISCLOSURE OF THE INVENTION

The road surface condition change estimation apparatus and the corresponding road surface condition change estimation method of the invention aim to estimate a change of a road surface condition in the vehicle driving state by a different technique from the prior art techniques. The road surface condition change estimation apparatus and the corresponding road surface condition change estimation method of the invention also aim to estimate an abrupt increase in friction coefficient on the road surface. The automobile of the invention aims to effectively handle a change of a road surface condition in the vehicle driving state.

At least part of the above and the other related objects is attained by the road surface condition change estimation apparatus, the automobile with such apparatus, and the corresponding road surface condition change estimation method of the invention having the arrangements discussed below.

The present invention is directed to a road surface condition change estimation apparatus that is mounted on an automobile and estimates a change in condition of a road surface where the automobile runs, and the road surface condition change estimation apparatus includes: a rotation angular acceleration measurement module that measures a rotation angular acceleration of a drive shaft, which is mechanically linked to drive wheels of the automobile; and
a condition change estimation module that estimates a change of a road surface condition corresponding to a variation in measured rotation angular acceleration.

The road surface condition change estimation apparatus of the invention estimates a change of the road surface condition according to a variation in rotation angular acceleration of the drive shaft mechanically linked to the drive wheels of the automobile. The wheelspin of the drive wheels due to a change of the road surface condition is observable as a variation in wheel speed corresponding to the degree of the change of the road surface condition and the magnitude of the torque acting on the drive wheels. Analysis of the variation in rotation angular acceleration of the drive shaft corresponding to the variation in wheel speed enables estimation of a change of the road surface condition. Here the terminology ‘the drive shaft mechanically linked to the drive wheels’ includes axles directly connected to the respective drive wheels, as well as a rotating shaft or another shaft connected to the pair of the drive wheels via a mechanical part, such as a differential gear. The ‘rotation angular acceleration measurement module’ may directly measure the rotation angular acceleration of the drive shaft or may measure the rotation angular velocity of the drive shaft and compute the rotation angular acceleration of the drive shaft from the measured rotation angular velocity.

In one preferable embodiment of the road surface condition change estimation apparatus of the invention, the condition change estimation module may estimate the change of the road surface condition, based on a variation in period of a time change of the measured rotation angular acceleration that increases to or over a predetermined reference value. Under no change of the road surface condition, the period of the time change of the rotation angular acceleration has only a slight variation but does not have any abrupt variation. Under a change of the road surface condition, however, the period of the time change of the rotation angular acceleration has an abrupt variation. By taking into account this phenomenon, the change of the road surface condition can be estimated, based on the variation in period of the time change of the measured rotation angular acceleration. In this case, the condition change estimation module may estimate the change of the road surface condition, in response to a variation in period of a time change of the measured rotation angular acceleration at or over a predetermined rate. Further, in this case, the condition change estimation module may estimate an abrupt increase in friction coefficient on the road surface, when the period of the time change of the measured rotation angular acceleration in an opposite peak detected immediately after a first peak, which appears after an increase of the rotation angular acceleration to or over a predetermined reference value, is shorter than the period of the time change in the first peak by or over the predetermined rate. This arrangement ensures estimation of an abrupt increase in friction coefficient on the road surface as the change of the road surface condition based on the variation in period, that is, a shift from a low μ road surface to a high μ road surface.

In another preferable embodiment of the road surface condition change estimation apparatus of the invention, the condition change estimation module may estimate the change of the road surface condition, based on a first peak value detected after an increase of the measured rotation angular acceleration to or over a predetermined reference value and an opposite second peak value detected immediately after the first peak value. In the event of the wheelspin of the drive wheels on the low μ road surface, the first peak appears immediately after the start of the wheelspin and the second peak appears in the course of convergence of the wheelspin. Under no change of the road surface condition, the peak value in the course of convergence of the wheelspin is within a specific range, which depends upon the friction coefficient of the road surface and the vehicle type. Under a change of the road surface condition, that is, in the event of a shift from the low μ road surface to the high μ road surface, however, the peak value in the course of convergence of the wheelspin exceeds the specific range. By taking into account this phenomenon, the change of the road surface condition can be estimated, based on the first peak value and the second peak value. In this case, the condition change estimation module may estimate the change of the road surface condition, in response to a variation of an absolute value of the second peak value relative to an absolute value of the first peak value by or over a predetermined rate. Further, in this case, the condition change estimation module may estimate an abrupt increase in friction coefficient on the road surface, when the absolute value of the second peak value is greater than the absolute value of the first peak value by or over the predetermined rate. This arrangement ensures estimation of an abrupt increase in friction coefficient on the road surface as the change of the road surface condition based on the first peak value and the second peak value, that is, a shift from a low μ road surface to a high μ road surface.

In another preferable embodiment of the road surface condition change estimation apparatus of the invention, the condition change estimation module may estimate the change of the road surface condition, based on a second peak value of the measured rotation angular acceleration detected after an increase to or over a predetermined reference value. As described previously, in the event of the wheelspin of the drive wheels on the low μ road surface, the second peak appears in the course of convergence of the wheelspin. Under no change of the road surface condition, the peak value is within a specific range. Under a change of the road surface condition, however, the peak value exceeds the specific range. By taking into account this phenomenon, the change of the road surface condition can be estimated, based on the second peak value. In this case, the condition change estimation module may estimate an abrupt increase in friction coefficient on the road surface, when an absolute value of the second peak value is not less than a preset level. This arrangement ensures estimation of an abrupt increase in friction coefficient on the road surface as the change of the road surface condition based on the second peak value, that is, a shift from a low μ road surface to a high μ road surface.

The present invention is also directed to an automobile that includes: a motor that outputs power to a drive shaft, which is mechanically linked to drive wheels of the automobile; a rotation angular acceleration measurement module that measures a rotation angular acceleration of the drive shaft; a condition change estimation module that estimates a change of a road surface condition corresponding to a variation in measured rotation angular acceleration; and a drive control module that drives and controls the motor to regulate a torque level output to the drive shaft according to a driver's operation and a vehicle driving state, while driving and controlling the motor in response to estimation of the change of the road surface condition by the condition change estimation module, to restrict the torque level output to the drive shaft for a preset time period.

The automobile of the invention drives and controls the motor to regulate the torque level output to the drive shaft according to the driver's operation and the vehicle driving state, while driving and controlling the motor in response to estimation of the change of the road surface condition by the condition change estimation module, to restrict the torque level output to the drive shaft for a preset time period. Restriction of the torque level output to the drive shaft desirably prevents a potential torque pulsation that may arise with the change of the road surface condition (for example, pulsation of the rotation angular acceleration). The ‘motor’ is desirably an electric motor or a motor generator having a quick control response.

In one preferable embodiment of the automobile of the invention, the drive control module may drive and control the motor in response to estimation of the change of the road surface condition by the condition change estimation module, to restrict the torque level output to the drive shaft to a torque limit value, which is set corresponding to a peak value of the rotation angular acceleration measured by the rotation angular acceleration measurement module. The peak value of the rotation angular acceleration is expected to reflect the degree of the change of the road surface condition to some extent. Setting the torque limit value corresponding to the peak value accordingly ensures adequate torque restriction. The torque limit value may be set to increase with an increase in peak value. In this case, the condition change estimation module may estimate the change of the road surface condition, in response to a variation in period of a time change of the measured rotation angular acceleration that increases to or over a predetermined reference value at or over a predetermined rate. Further, the condition change estimation module may estimate the change of the road surface condition, in response to a variation of an absolute value of an opposite second peak value detected immediately after a first peak value relative to an absolute value of the first peak value detected after an increase of the measured rotation angular acceleration to or over a predetermined reference value by or over a predetermined rate. Moreover, the condition change estimation module may estimate the change of the road surface condition, when an absolute value of a second peak value of the measured rotation angular acceleration detected after an increase to or over a predetermined reference value is not less than a preset level.

A first road surface condition change estimation method of the invention estimates a change in condition of a road surface where the automobile runs, and the first road surface condition change estimation method includes the steps of: (a) measuring a rotation angular acceleration of a drive shaft, which is mechanically linked to drive wheels of the automobile; and (b) estimating a change of a road surface condition, in response to a variation in period of a time change of the measured rotation angular acceleration that increases to or over a predetermined reference value at or over a predetermined rate.

The first road surface condition change estimation method of the invention estimates a change of the road surface condition, when the period of the time change of the rotation angular acceleration of the drive shaft that increases to or over a predetermined reference value has a variation of or over a predetermined rate. The change of the road surface condition can be estimated, based on the variation in period of the time change of the rotation angular acceleration of the drive shaft. Such estimation is ascribed to the fact that the period of the time change of the rotation angular acceleration of the drive shaft has only a slight variation but does not have any abrupt variation under no change of the road surface condition, while having an abrupt variation under a change of the road surface condition, as described previously.

A second road surface condition change estimation method of the invention estimates a change in condition of a road surface where the automobile runs, and the second road surface condition change estimation method includes the steps of: (a) measuring a rotation angular acceleration of a drive shaft, which is mechanically linked to drive wheels of the automobile; and (b) estimating a change of a road surface condition, in response to a variation of an absolute value of an opposite second peak value detected immediately after a first peak value relative to an absolute value of the first peak value detected after an increase of the measured rotation angular acceleration to or over a predetermined reference value by or over a predetermined rate.

The second road surface condition change estimation method of the invention estimates a change of the road surface condition, when the absolute value of an opposite second peak value detected immediately after a first peak value, which is detected after an increase in measured rotational angular acceleration of the drive shaft to or over a predetermined reference value, relative to the absolute value of the first peak value varies by or over a predetermined rate. The change of the road surface condition can be estimated, based on the first peak value and the second peak value of the measured rotation angular acceleration of the drive shaft. Such estimation is ascribed to the fact that a change of the road surface condition significantly varies the second peak value in the course of convergence of the wheelspin relative to the first peak value of the rotation angular acceleration immediately after the start of the wheelspin of the drive wheels, as described previously.

A third road surface condition change estimation method of the invention estimates a change in condition of a road surface where the automobile runs, and the third road surface condition change estimation method includes the steps of: (a) measuring a rotation angular acceleration of a drive shaft, which is mechanically linked to drive wheels of the automobile; and (b) estimating a change of a road surface condition, when an absolute value of a second peak value of the measured rotation angular acceleration detected after an increase to or over a predetermined reference value is not less than a preset level.

The third road surface condition change estimation method of the invention estimates a change of the road surface condition, when the absolute value of a second peak value detected after an increase in measured rotation angular acceleration of the drive shaft to or over a predetermined reference value is not less than a preset level. The change of the road surface condition can be estimated, based on the second peak value of the rotation angular acceleration of the drive shaft. Such estimation is ascribed to the fact that the second peak value is significantly higher under a change of the road surface condition than the value under no change of the road surface condition, as described previously.

### BRIEF DESCRIPTION OF THE DRAWINGS

FIG. 1 schematically illustrates the configuration of an electric vehicle 10 equipped with a control apparatus 20 of a motor 12 functioning as a road surface condition change estimation apparatus in one embodiment of the invention;

FIG. 2 is a flowchart showing a road surface condition change estimation routine executed by the electronic control unit 40 of the embodiment;

FIG. 3 shows a time change of the rotation angular acceleration α under no change of the road surface condition and a time change of the rotation angular acceleration α under a change of the road surface condition;

FIG. 4 shows one example of the torque restriction rate setting map;

FIG. 5 shows one example of the maximum torque setting map;

FIG. 6 is a flowchart showing a motor drive control routine executed by the electronic control unit 40;

FIG. 7 shows one example of the torque demand setting map;

FIG. 8 is a flowchart showing a skid state determination routine executed by the electronic control unit 40;

FIG. 9 is a flowchart showing a skid occurring state control routine executed by the electronic control unit 40;

FIG. 10 is a flowchart showing a skid convergence state control routine executed by the electronic control unit 40;

FIG. 11 is a flowchart showing a torque restoration limit setting routine executed by the electronic control unit 40;

FIG. 12 schematically illustrates the configuration of a hybrid vehicle 110;

FIG. 13 schematically illustrates the configuration of a hybrid vehicle 210; and

FIG. 14 schematically illustrates the configuration of a hybrid vehicle 310.

### BEST MODES OF CARRYING OUT THE INVENTION

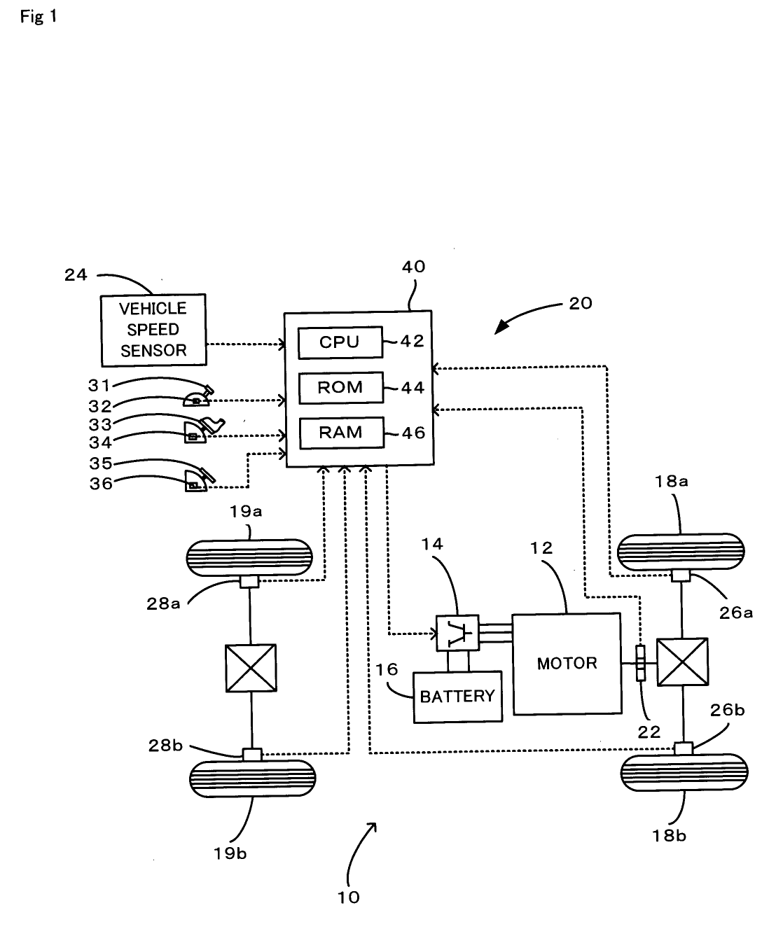

One mode of carrying out the invention is described below as a preferred embodiment. FIG. 1 schematically illustrates the configuration of an electric vehicle 10 equipped with a control apparatus 20 of a motor 12 functioning as a road surface condition change estimation apparatus in one embodiment of the invention. As illustrated, the motor control apparatus 20 of the embodiment is constructed to drive and control a motor 12, which uses electric power supplied from a battery 16 via an inverter circuit 14 and outputs power to a drive shaft linked to drive wheels 18a, 18b of the electric vehicle 10. The motor control apparatus 20 includes a rotation angle sensor 22 that measures a rotation angle θ of a rotating shaft of the motor 12, a vehicle speed sensor 24 that measures a driving speed of the electric vehicle 10, wheel speed sensors 26a, 26b, 28a, and 28b that respectively measure wheel speeds of the drive wheels (front wheels) 18a and 18b and driven wheels (rear wheels) 19a and 19b driven by the drive wheels 18a and 18b, diversity of sensors that detect the driver's various operations (for example, a gearshift position sensor 32 that detects the driver setting position of a gearshift lever 31, an accelerator pedal position sensor 34 that detects the driver's step-on amount of an accelerator pedal 33 (an accelerator opening), and a brake pedal position sensor 36 that detects the driver's step-on amount of a brake pedal 35 (a brake opening)), and an electronic control unit 40 that controls the respective constituents of the apparatus.

The motor 12 is, for example, a known synchronous motor generator that functions both as a motor and a generator. The inverter circuit 14 includes multiple switching elements that convert a supply of electric power from the battery 16 into another form of electric power suitable for actuation of the motor 12. The structures of the motor 12 and the inverter circuit 14 are well known in the art and are not the key part of this invention, thus not being described here in detail.

The electronic control unit 40 is constructed as a microprocessor including a CPU 42, a ROM 44 that stores processing programs, a RAM 46 that temporarily stores data, and input and output ports (not shown). The electronic control unit 40 receives, via the input port, the rotation angle θ of the rotating shaft of the motor 12 measured by the rotation angle sensor 22, the vehicle speed V of the electric vehicle 10 measured by the vehicle speed sensor 24, the wheel speeds Vf1 and Vf2 of the drive wheels 18a and 18b and the wheel speeds Vr1 and Vr2 of the driven wheels 19a and 19b measured by the wheel speed sensors 26a, 26b, 28a, and 28b, the gearshift position detected by the gearshift position sensor 32, the accelerator opening Acc detected by the accelerator pedal position sensor 34, and the brake opening detected by the brake pedal position sensor 36. The electronic control unit 40 outputs control signals, for example, switching control signals to the switching elements of the inverter circuit 14 to drive and control the motor 12, via the output port.

The description regards the operations of the motor control apparatus 20 constructed as discussed above, especially a series of processing to estimate a change of road surface condition in the driving state of the electric vehicle 10 and a series of operations of driving and controlling the motor 12 in the event of the occurrence of a skid due to the wheelspin of the drive wheels 18a and 18b of the electric vehicle 10, based on the estimation result of the change of the road surface condition. The process of estimating the change of the road surface condition and the process of driving and controlling the motor 12 are described in this order.

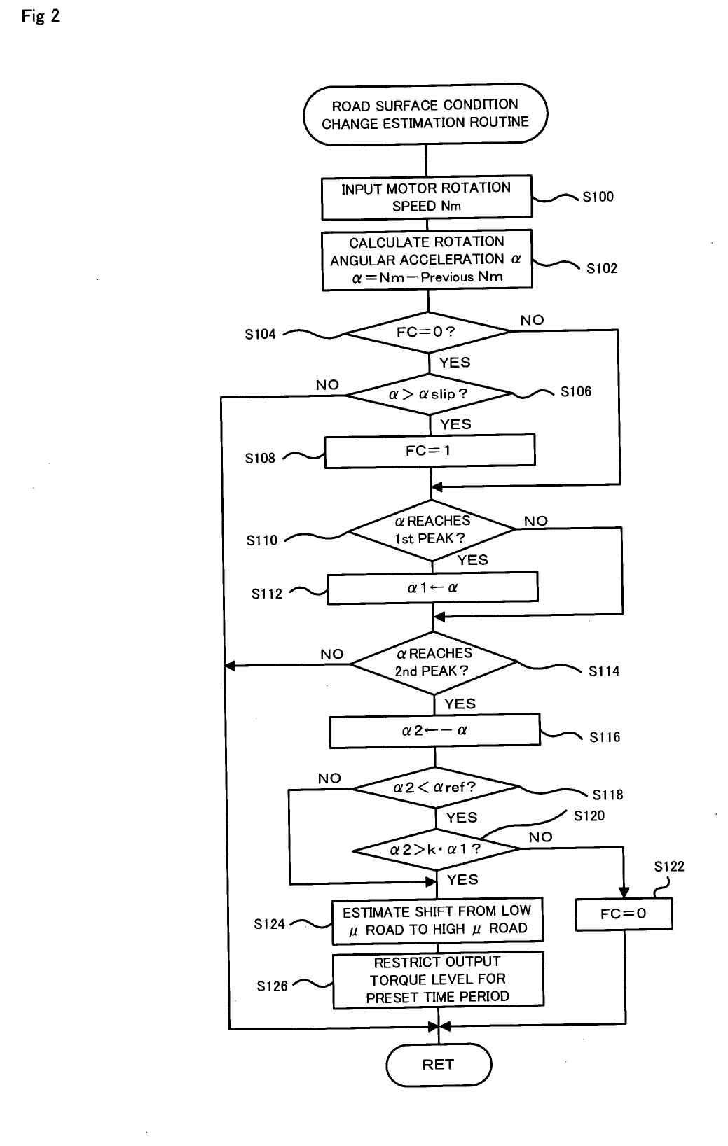

FIG. 2 is a flowchart showing a road surface condition change estimation routine executed by the electronic control unit 40 of the embodiment. This estimation routine is executed repeatedly at preset time intervals (for example, at every 8 msec). When the road surface condition change estimation routine starts, the CPU 42 of the electronic control unit 40 first inputs a motor rotation speed Nm calculated from the rotation angle θ measured by the rotation angle sensor 22 (step S100), and calculates a rotation angular acceleration α from the input motor rotation speed Nm (step S102). The calculation of the rotation angular acceleration α in this embodiment subtracts a previous rotation speed Nm input in a previous cycle of this routine from a current rotation speed Nm input in the current cycle of this routine (current rotation speed Nm—previous rotation speed Nm). The unit of the rotation angular acceleration α is [rpm/8 msec] since the execution interval of this routine is 8 msec in this embodiment, where the rotation speed Nm is expressed by the number of rotations per minute [rpm]. Any other suitable unit may be adopted for the rotation angular acceleration α as long as the rotation angular acceleration α is expressible as a time rate of change of rotation speed. In order to minimize a potential error, the angular acceleration α and the wheel speed difference ΔV may be an average of angular accelerations and an average of wheel speed differences calculated in a preset number of cycles of this routine (for example, 3).

The CPU 42 subsequently checks the value of a road surface condition change flag FC (Step S104). A value ‘1’ representing a premise of estimating a change of road surface condition is set to the road surface condition change flag FC (step S108), when it is determined at step S106 that the calculated rotation angular acceleration α exceeds a preset threshold value αslip, which suggests the occurrence of a skid induced by the wheelspin of the drive wheels 18a and 18b. When the road surface condition change flag FC has a value ‘0’, the calculated rotation angular acceleration α is compared with the preset threshold value αslip (step S106). When the calculated rotation angular acceleration α is not greater than the preset threshold value αslip, this estimation routine is terminated. When the calculated rotation angular acceleration α is greater than the preset threshold value αslip, on the other hand, the road surface condition change flag FC is set equal to ‘1’ (step S108).

After the value ‘1’ is set to the road surface condition change flag FC or when it is determined at step S104 that the road surface condition change flag FC has the value ‘1’, the CPU 42 determines whether the rotation angular acceleration α reaches a first peak (step S110) When the rotation angular acceleration α reaches the first peak, the rotation angular acceleration α at the moment is set to a first peak angular acceleration α1 (step S112) The rotation angular acceleration α reaches the first peak at the timing when the time differential of the rotation angular acceleration α shifts from positive to negative after the increase of the rotation angular acceleration α over the preset threshold value αslip. After setting the first peak angular acceleration α1, the CPU 42 determines whether the rotation angular acceleration α reaches a second peak (step S114). When the rotation angular acceleration α reaches the second peak, the product of the rotation angular acceleration α at the moment and ‘−1’ is set to a second peak angular acceleration α2 (step S116). The second peak is a negative peak appearing immediately after the first peak. Multiplication of the rotation angular acceleration α by ‘−1’ to set the second peak angular acceleration α2 changes the symbol of the second peak angular acceleration α2 to be identical with the symbol of the first peak angular acceleration α1.

After setting the first peak angular acceleration α1 and the second peak angular acceleration α2, the CPU 42 compares the second peak angular acceleration α2 with a preset reference value αref (step S118) and with the product of the first peak angular acceleration α1 and a constant k (step S120). The reference value αref is set to be greater than an expected maximum value of the first peak angular acceleration α1 in the event of occurrence of a wheelspin-induced skid. For example, when the expected maximum value of the first peak angular acceleration α1 was 100 [rpm/8 msec] in an experiment of causing a wheelspin-induced skid of the electric vehicle 10 on a low μ road surface, the reference value αref is, for example, set equal to 120 or 140. The constant k should be not less than 1 and may be, for example, 1.2 or 1.4.

When the second peak angular acceleration α2 is less than the preset reference value αref and is not greater than the product of the first peak angular acceleration α1 and the constant k, the CPU 42 estimates no change of the road surface condition and sets the value 101 to the road surface condition change flag FC (step S122). The road surface condition change estimation routine is here terminated. When the second peak angular acceleration α2 is not less than the preset reference value αref or when the second peak angular acceleration α2 is less than the preset reference value αref but is greater than the product of the first peak angular acceleration α1 and the constant k, on the other hand, the CPU 42 estimates a change of the road surface condition, that is, a shift from a low μ road surface to a high μ road surface (step S124). In the event of the wheelspin of the drive wheels 18a and 18b on the low μ road surface, the first peak appears immediately after the start of the wheelspin and the second peak appears in the course of convergence of the wheelspin. Under no change of the road surface condition, the variation in second peak angular acceleration α2 in the course of convergence of the wheelspin is within a specific range, which depends upon the friction coefficient of the road surface and the vehicle type. Under a change of the road surface condition, that is, in the event of a shift from the low μ road surface to the high μ road surface, however, the variation in second peak angular acceleration α2 the course of convergence of the wheelspin exceeds the specific range. A change of the road surface condition (that is, a shift from the low μ road surface to the high μ road surface) is thus estimated when the second peak angular acceleration α2 is not less than the preset reference value αref, which is greater than the expected maximum value of the first peak angular acceleration α1 in the event of occurrence of a wheelspin-induced skid. A change of the road surface condition is also estimated when the second peak angular acceleration α2 is less than the preset reference value αref but is greater than the product of the first peak angular acceleration α1 and the constant k. Such estimation is ascribed to the result of an experiment showing that the value of the second peak generally appearing in the course of convergence of the wheelspin is not greater than the value of the first peak unless the road surface condition has a change.

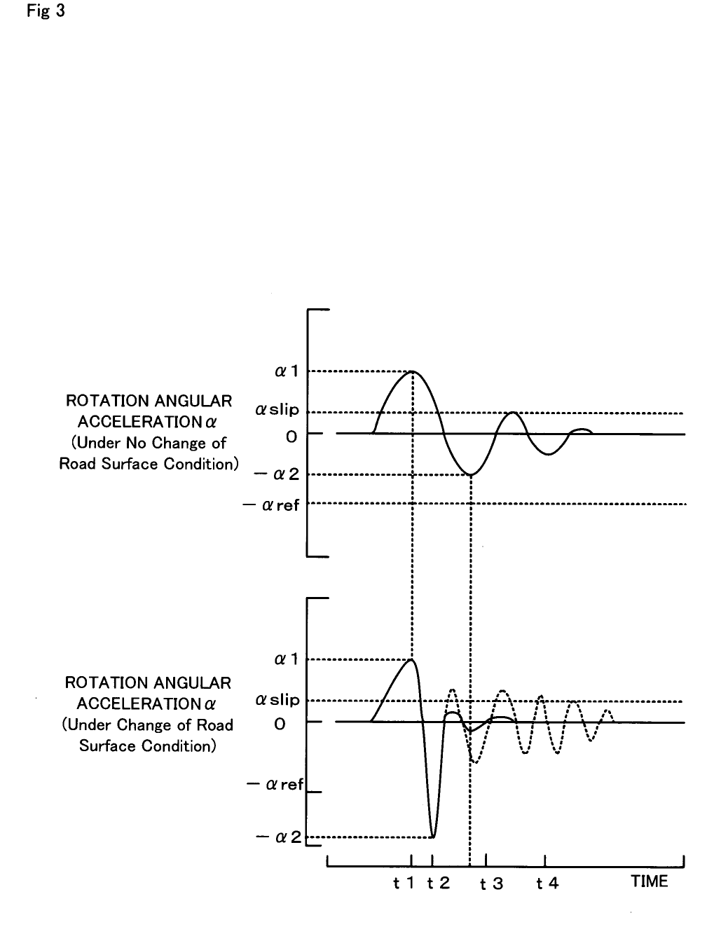

FIG. 3 shows a time change of the rotation angular acceleration α under no change of the road surface condition and a time change of the rotation angular acceleration α under a change of the road surface condition. As shown in the graph, under no change of the road surface condition, the absolute value of the second peak angular acceleration α2 is smaller than not only the absolute reference value α but the absolute value of the first peak angular acceleration α1. Under a change of the road surface condition (that is, a shift from the low μ road surface to the high μ road surface), the rotation angular acceleration α has an abrupt decrease to the negative value. The absolute value of the second peak angular acceleration α2 is greater than the absolute value of the first peak angular acceleration α1 and may also be even greater than the absolute reference value αref in some cases. The procedure of this embodiment estimates a change of the road surface condition, that is, a shift from the low μ road surface to the high μ road surface, in the course of convergence of the wheelspin-induced skid based on the comparison between the second peak angular acceleration α2 and the preset reference value αref. When the second peak angular acceleration α2 is less than the preset reference value αref, a change of the road surface condition is estimated, based on the comparison between the second peak angular acceleration α2 and the product of the first peak angular acceleration α1 and the constant k of not less than 1.

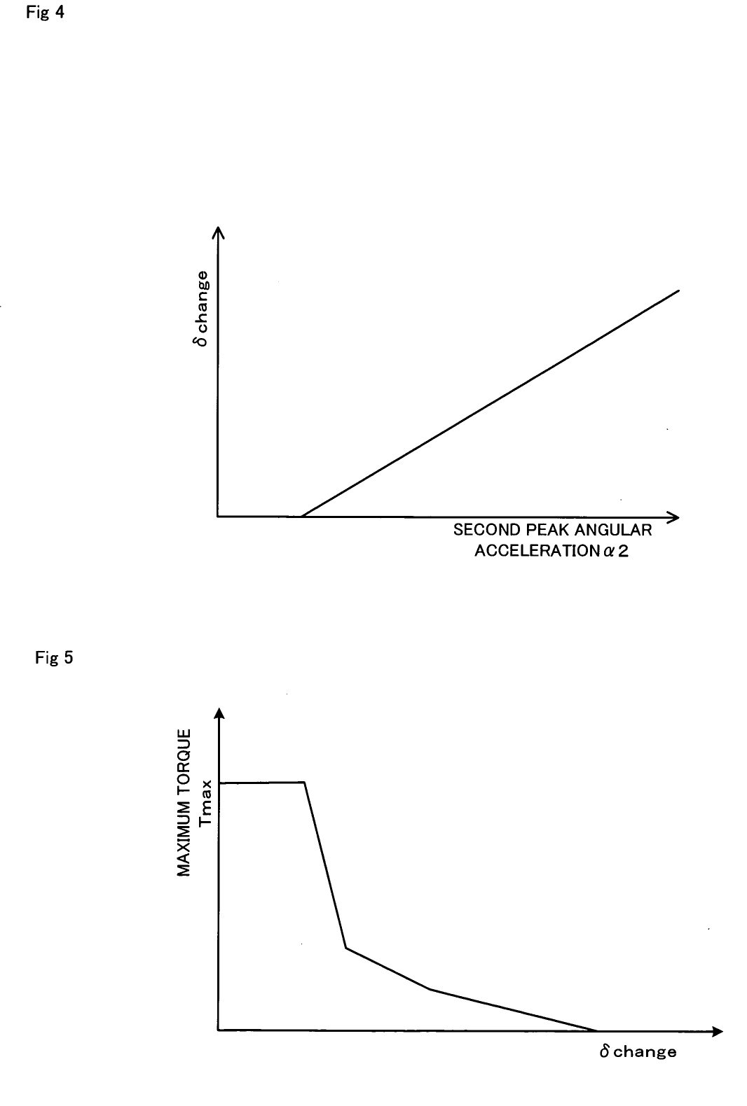

In response to estimation of a change of the road surface condition, the CPU 42 restricts the torque level output from the motor 12 for a preset time period (step S126) and terminates this road surface condition change estimation routine. The torque restriction method of this embodiment refers to a torque restriction rate setting map shown in FIG. 4 and sets a torque restriction rate δchange corresponding to the second peak angular acceleration α2. The torque restriction method then reads a maximum torque Tmax corresponding to the torque restriction rate δchange from a maximum torque setting map shown in FIG. 5. The torque restriction rate δchange is set to increase with an increase in second peak angular acceleration α2 as shown in the map of FIG. 4. The maximum torque Tmax is set to decrease with an increase in torque restriction rate δchange as shown in the map of FIG. 5. Namely a smaller value is set to the maximum torque Tmax with an increase in second peak angular acceleration α2. The torque restriction of limiting the torque level output from the motor 12 to the maximum torque Tmax for the preset time period reduces the vibration of the rotation angular acceleration α, that is, the vibration in the longitudinal direction of the vehicle, which may occur with a change of the road surface condition. An adequate value is set to the time period of the torque restriction by actually measuring the time require for convergence of the vibration under a change of the road surface condition. The curve of the broken line in FIG. 3 shows a time change of the rotation angular acceleration α without such torque restriction for the preset time period under a change of the road surface condition.

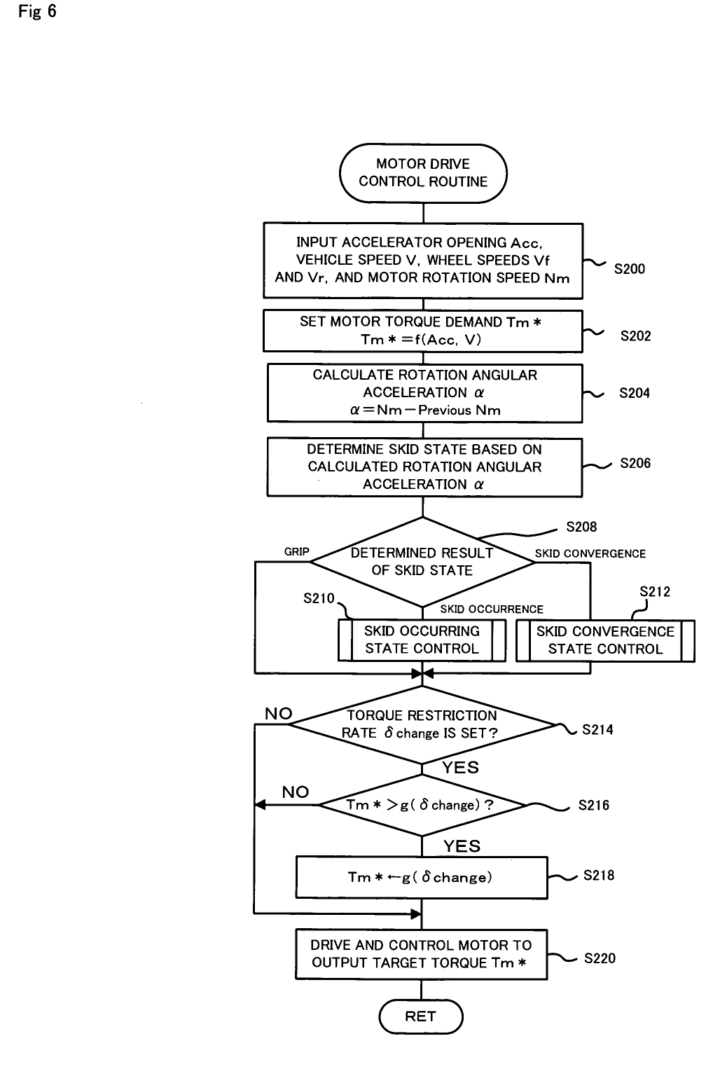

The description now regards the drive control of the motor 12 based on the estimation result of the road surface condition change. FIG. 6 is a flowchart showing a motor drive control routine executed by the electronic control unit 40. This motor drive control routine is executed repeatedly at preset time intervals (for example, at every 8 msec).

When the motor drive control routine starts, the CPU 42 of the electronic control unit 40 first inputs the accelerator opening Acc from the accelerator pedal position sensor 34, the vehicle speed V from the vehicle speed sensor 24, wheel speeds Vf and Vr from the wheel speed sensors 26a, 26b, 28a, and 28b, and the motor rotation speed Nm calculated from the rotation angle θ measured by the rotation angle sensor 22 (step S200). In this embodiment, the wheel speeds Vf and Vr respectively represent an average of the wheel speeds Vf1 and Vf2 measured by the wheel speed sensors 26a and 26b and an average of the wheel speeds Vr1 and Vr2 measured by the wheel speed sensors 28a and 28b. The vehicle speed V is measured by the vehicle speed sensor 24 in this embodiment, but may alternatively be calculated from the wheel speeds Vf1, Vf2, Vr1, and Vr2 measured by the wheel speed sensors 26a, 26b, 28a, and 28b.

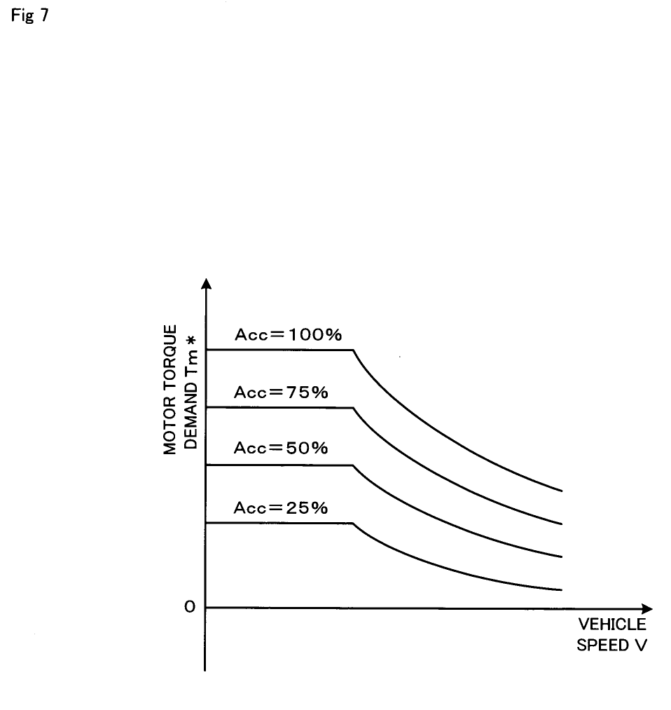

The CPU 42 then sets a torque demand Tm* of the motor 12 according to the input accelerator opening Acc and the input vehicle speed V (step S202). A concrete procedure of setting the motor torque demand Tm* in this embodiment stores in advance variations in motor torque demand Tm* against the accelerator opening Acc and the vehicle speed V as a map in the ROM 44 and reads the motor torque demand Tm* corresponding to the given accelerator opening Acc and the given vehicle speed V from the map. One example of this map is shown in FIG. 7.

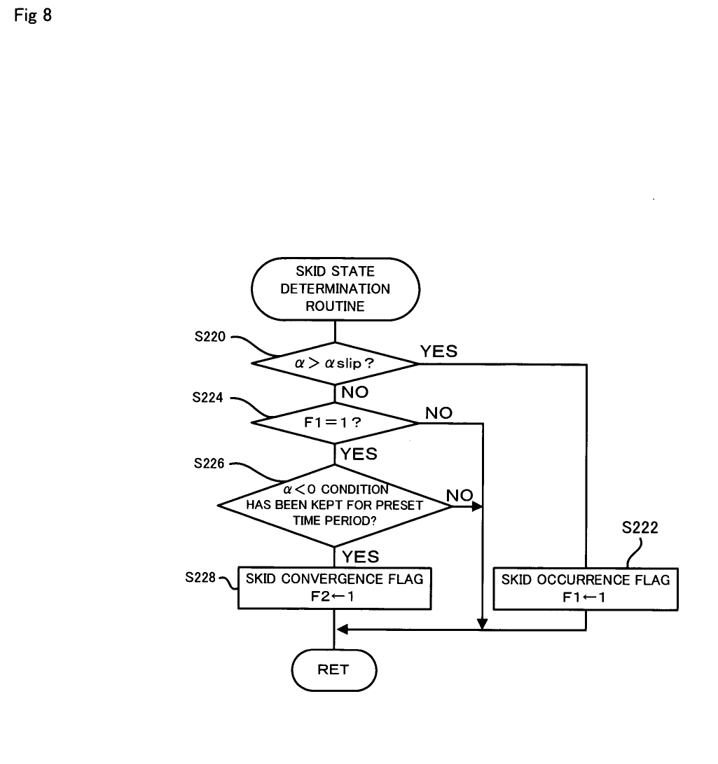

The CPU 42 subsequently calculates the rotation angular acceleration α from the motor rotation speed Nm input at step S200 (step S204) and determines a skid state of the drive wheels 18a and 18b based on the calculated rotation angular acceleration α (step S206). The determination of the skid state follows a skid state determination routine shown in FIG. 8. The description of the motor drive control routine of FIG. 6 is suspended, and the skid state determination routine of FIG. 8 is described first. When the skid state determination routine starts, the CPU 42 of the electronic control unit 40 compares the rotation angular acceleration α calculated at step S204 in the control routine of FIG. 6 with a preset threshold value αslip, which suggests the occurrence of a wheelspin-induced skid (step S220). When the calculated rotation angular acceleration α exceeds the preset threshold value αslip, the CPU 42 determines the occurrence of a skid on the drive wheels 18a and 18b and sets the value ‘1’ to a skid occurrence flag F1 representing the occurrence of a skid (step S222), before exiting from this skid state determination routine. When the calculated rotation angular acceleration α does not exceed the preset threshold value αslip, on the other hand, the CPU 42 determines whether the skid occurrence flag F1 is equal to 1 (step S224). When the skid occurrence flag F1 is equal to 1, the CPU 42 subsequently determines whether the calculated rotation angular acceleration α has been kept negative for a preset time period (step S226). In the case of the negative rotation angular acceleration α kept for the preset time period, the CPU 42 determines convergence of the skid occurring on the drive wheels 18a and 18b and sets the value ‘1’ to a skid convergence flag F2 (step S228), before exiting from this skid state determination routine. When the rotation angular acceleration α is not negative or when the negative rotation angular acceleration α has not been kept for the preset time period even under the setting of the skid occurrence flag F1 equal to 1, the CPU 42 determines no convergence of the skid and terminates this skid state determination routine.

Referring back to FIG. 6, the motor drive control routine executes required control (step S210 or step S212) according to the skid state determined by the skid state determination routine of FIG. 8, for example, the skid occurrence state or the skid convergence state. Setting the value ‘1’ to the skid occurrence flag F1 and the value ‘0’ to the skid convergence flag F2 suggests the occurrence of a skid and triggers skid occurring state control (step S210). Setting the value ‘1’ to both the skid occurrence flag F1 and the skid convergence flag F2 suggests convergence of the skid and triggers skid convergence state control (step S212). The details of the respective controls are described later.

The CPU 42 determines whether the torque restriction for the preset time period is being executed, that is, whether the torque restriction rate δchange has been set by the road surface condition change estimation routine of FIG. 2 (step S214). Under the condition of no setting the torque restriction rate δchange in the grip state, the CPU 42 drives and controls the motor 12 to output a torque corresponding to the torque demand Tm* set at step S202 (step S220). Under the condition of setting the torque restriction rate δchange, on the other hand, the CPU 42 restricts the motor torque demand Tm* to the maximum torque Tmax, which is read corresponding to the torque restriction rate δchange from the maximum torque setting map of FIG. 5 (steps S216 and S218) and drives and controls the motor 12 to output a torque corresponding to the restricted torque demand Tm* (steps S220). The motor drive control routine is then terminated. Such torque restriction effectively reduces the vibration of the rotation angular acceleration α, that is, the vibration in the longitudinal direction of the vehicle, which may occur with a change of the road surface condition, as mentioned previously.

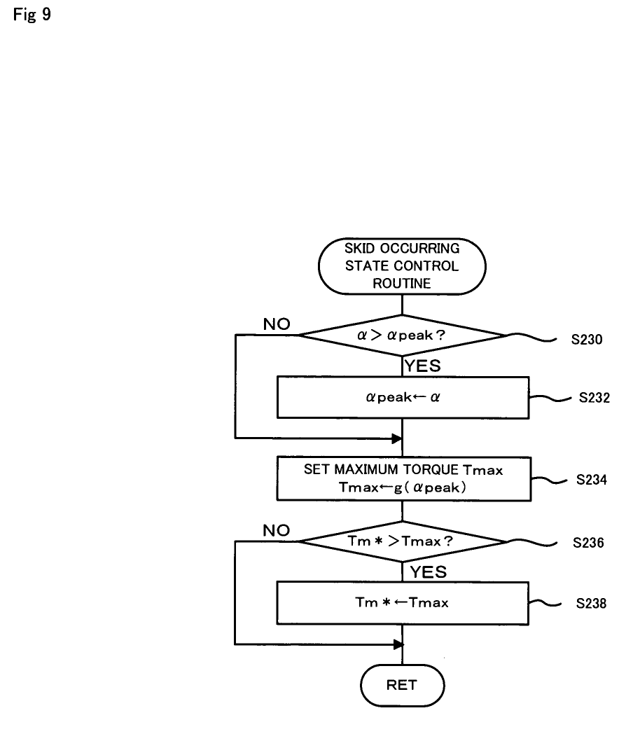

The skid occurring state control of step S210 follows a skid occurring state control routine shown in the flowchart of FIG. 9. The skid occurring state control first compares the rotation angular acceleration α with a preset peak value αpeak (step S230). When the rotation angular acceleration α exceeds the preset peak value αpeak, the peak value αpeak is updated to the current value of the rotation angular acceleration α (step S232). The peak value αpeak represents a peak of the rotation angular acceleration α increasing due to a skid and is initially set equal to 0. Until the rotation angular acceleration α increases to reach its maximum, the peak value speak is successively updated to the current value of the rotation angular acceleration α. When the increasing rotation angular acceleration α reaches its maximum, the maximum value of the increasing rotation angular acceleration α is fixed to the peak value αpeak. After setting the peak value speak, the skid occurring state control sets the maximum torque Tmax as the upper limit of the torque level output from the motor 12 corresponding to the peak value αpeak (step S234). The procedure of this embodiment refers to the maximum torque setting map of FIG. 5 with substitution of the abscissa to the rotation angular acceleration α. In this modified map, the maximum torque Tmax decreases with an increase in rotation angular acceleration α. The greater peak value speak of the increasing rotation angular acceleration α, that is, the heavier skid, sets the smaller value to the maximum torque Tmax and limits the torque level output from the motor 12 to the smaller maximum torque Tmax. The skid occurring state control restricts the motor torque demand Tm* to the maximum torque Tmax (steps S236 and S238) and is then terminated. The torque level output from the motor 12 in the occurrence of a skid is limited to a lower level (that is, the maximum torque Tmax corresponding to the peak value speak of the rotation angular acceleration in the map of FIG. 5) for immediate reduction of the skid. This limitation effectively reduces the skid.

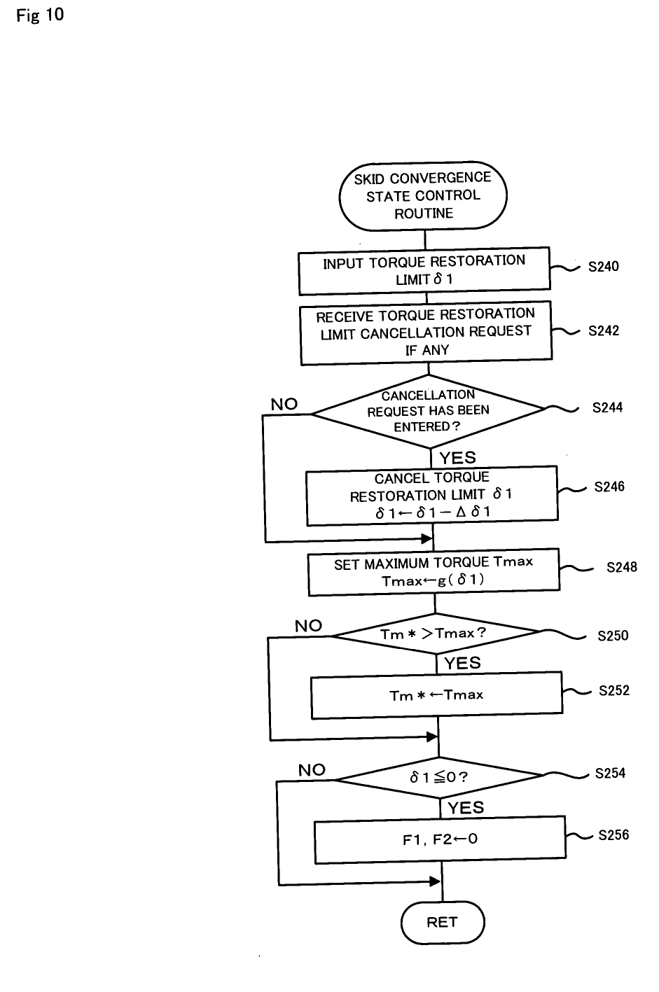

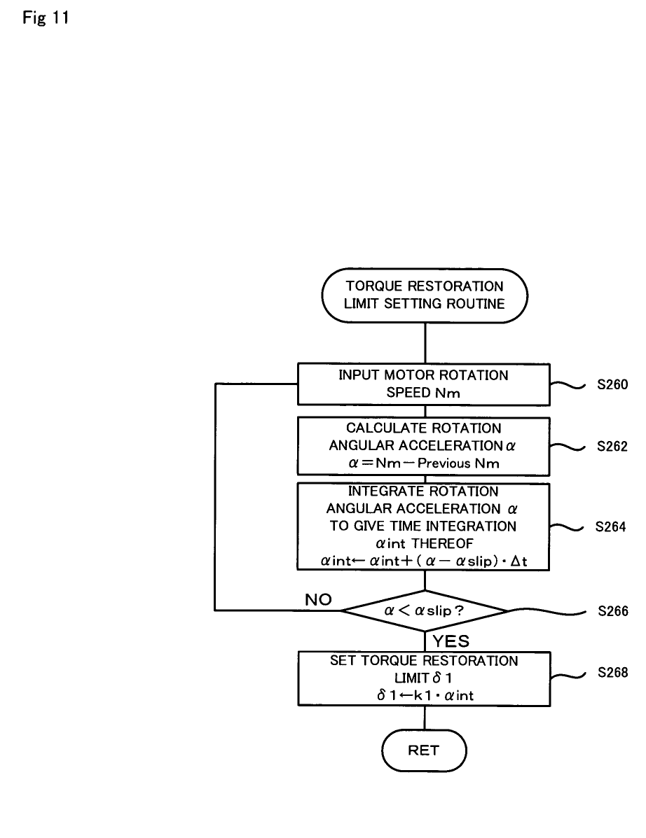

The skid convergence state control of step S212 follows a skid convergence state control routine shown in the flowchart of FIG. 10. The skid convergence state control first inputs a torque restoration limit δ1 (expressed in the same unit [rpm/8 msec] as the rotation angular acceleration) (step S240). The torque restoration limit 61 is a parameter used to set a degree of restoration from the torque restriction by increasing the maximum torque Tmax, which has been limited corresponding to the peak value αpeak of the rotation angular acceleration by the skid occurring state control. The torque restoration limit δ1 is set according to a torque restoration limit setting routine shown in FIG. 11. The torque restoration limit setting routine of FIG. 11 is executed when the skid occurrence flag F1 is set equal to 1 (that is, when the calculated rotation angular acceleration α exceeds the preset threshold value αslip) at step S222 in the skid state determination routine of FIG. 8. The torque restoration limit setting routine inputs the motor rotation speed Nm calculated from the rotation angle θ measured by the rotation angle sensor 22, calculates the rotation angular acceleration α from the input motor rotation speed Nm, and integrates the rotation angular acceleration α to give a time integration αint thereof over an integration interval since the increase of the rotation angular acceleration α over the preset threshold value αslip (steps S260 to S264). These steps are repeated until the rotation angular acceleration α becomes less than the preset threshold value αslip. In this embodiment, the time integration αint of the rotation angular acceleration α is given by Equation (1) below, where Δt denotes a time interval of the repeated execution of steps S260 to S266 as described below and is set equal to 8 msec in this embodiment:
αintζαint+(α−αslip)·Δt (1)

After the rotation angular acceleration α becomes less than the preset threshold value αslip, the torque restoration limit 67 1 is set by multiplying the computed time integration αint by a predetermined coefficient k1 (step S268). The torque restoration limit setting routine is here terminated. This routine calculates the torque restoration limit δ1 by multiplication of the predetermined coefficient k1. One modified procedure may prepare in advance a map representing a variation in maximum torque Tmax against the time integration αint and read the maximum torque Tmax corresponding to the given time integration αint from the map.

Referring back to the flowchart of FIG. 10, after input of the torque restoration limit δ1, the skid convergence state control receives a cancellation request of the torque restoration limit δ1 (step S242) if any and determines the entry or non-entry of the cancellation request (step S244). This step determines input or non-input of a request for canceling the torque restoration limit δ1, which is the parameter to set the degree of restoration from the torque restriction (a request for gradually increasing the degree of restoration). The procedure of this embodiment receives a cancellation request to cancel the restoration limit with a cancellation rate Δδ1, which is initially set equal to 0 and increments by a preset increment amount every time a preset waiting time interval has elapsed since the first cycle of this routine. The waiting time interval and the increment amount of the cancellation rate Δδ1 may be varied according to the demand level of the driver's cancellation request, for example, according to the magnitude of the accelerator opening representing the driver's torque output demand. In the entry of a cancellation request, the torque restoration limit δ1 is updated by subtracting the cancellation rate Δδ1 from the previous setting of the torque restoration limit δ1 input at step S240 (step S246). In the non-entry of a cancellation request, that is, when the preset waiting time interval has not yet elapsed since the start of this routine, on the other hand, the torque restoration limit δ1 is not cancelled.

The skid convergence state control sets the maximum torque Tmax as the upper limit of the torque level output from the motor 12 corresponding to the torque restoration limit δ1 by referring to the maximum torque setting map of FIG. 5 (step S248) and limits the motor torque demand Tm* to the maximum torque Tmax (steps S250 and S252). The skid convergence state control determines whether the torque restoration limit δ1 is cancelled to or below 0 (step S254). In the case of cancellation of the torque restoration limit δ1 to or below 0, both the skid occurrence flag F1 and the skid convergence flag F2 are reset to zero (step S256). The skid convergence state control routine is then terminated. The torque control of the motor 12 based on the torque restoration limit δ1, which is set corresponding to the time integration of the rotation angular acceleration α, ensures restoration of the restricted torque to an adequate level according to the current skid state. Under the condition of a large time integration of the rotation angular acceleration α, which suggests a high potential for reoccurrence of a skid, the torque restoration level under the convergence of the skid is set low. Under the condition of a small time integration of the rotation angular acceleration α, which suggests a low potential for reoccurrence of a skid, on the contrary, the torque restoration level under the convergence of the skid is set high to effectively prevent the reoccurrence of a skid without excessive torque restriction.

While the torque demand Tm* of the motor 12 is limited by the skid occurring state control of step S210 or by the skid convergence state control of step S212, the restricted torque demand Tm* is further limited to the maximum torque Tmax corresponding to the torque restriction rate δchange, which is set according to the estimation result of the road surface condition change at steps S214 to S218 in the flowchart of FIG. 6. This arrangement effectively reduces the vibration of the rotation angular acceleration α, that is, the vibration in the longitudinal direction of the vehicle, which may occur with a change of the road surface condition, regardless of the skid occurring state or the skid convergence state.

As described above, the electric vehicle 10 of the embodiment estimates a change of the road surface condition, based on only the second peak angular acceleration α2 or based on both the first peak angular acceleration α1 and the second peak angular acceleration α2 of the rotation angular acceleration α of the drive shaft linked with the axle of the drive wheels 18a and 18b in the event of the occurrence of a wheelspin-induced skid. In response to estimation of a change of the road surface condition, the electric vehicle 10 of the embodiment restricts the torque level output from the motor 12 for a preset time period. This arrangement thus effectively reduces the vibration of the rotation angular acceleration α (the vibration in the longitudinal direction of the vehicle), which may occur with a change of the road surface condition.

The electric vehicle 10 of the embodiment estimates a change of the road surface condition when the second peak angular acceleration α2 is not less than the preset reference value αref or when the second peak angular acceleration α2 is less than the preset reference value αref but is greater than the product of the first peak angular acceleration α1 and the constant k. One modified procedure may estimate a change of the road surface condition only when the second peak angular acceleration α2 is not less than the preset reference value αref. Another modified procedure may estimate a change of the road surface condition when the second peak angular acceleration α2 is greater than the product of the first peak angular acceleration α1 and the constant k.

The electric vehicle 10 of the embodiment estimates a change of the road surface condition, based on the second peak angular acceleration α2 and the first peak angular acceleration α1. One modified procedure may estimate a change of the road surface condition, based on a difference between a first period of a time change of the rotation angular acceleration α including the first peak angular acceleration α1 and a second period of a time change of the rotation angular acceleration α including the second peak angular acceleration α2 as shown in FIG. 3. For example, a shift from the low μ road surface to the high μ road surface may be estimated when the second period is smaller than the product of the first period and a constant r of less than 1.

The electric vehicle 10 of the embodiment refers to the torque restriction rate setting map and sets the torque restriction rate δchange corresponding to the second peak angular acceleration α2, in response to estimation of a change of the road surface condition. The torque level of the motor 12 is limited to the maximum torque Tmax, which is set corresponding to the torque restriction rate δchange by referring to the maximum torque setting map. One modified procedure may prepare a map representing a variation in maximum torque Tmax against the second peak angular acceleration α2, set the maximum torque Tmax corresponding to the given second peak angular acceleration α2 by referring to the map, and restrict the torque level of the motor 12 to the maximum torque Tmax.

The electric vehicle 10 of the embodiment sets the maximum torque Tmax corresponding to the second peak angular acceleration α2, in response to estimation of a change of the road surface condition. The maximum torque Tmax may otherwise be set, based on a difference between the first peak angular acceleration α1 and the second peak angular acceleration α2, based on a rate of the second peak angular acceleration α2 to the first peak angular acceleration α1, or based on a rate of the period of a time change of the rotation angular acceleration α including the second peak angular acceleration α2 to the period of a time change of the rotation angular acceleration α including the first peak angular acceleration α1.

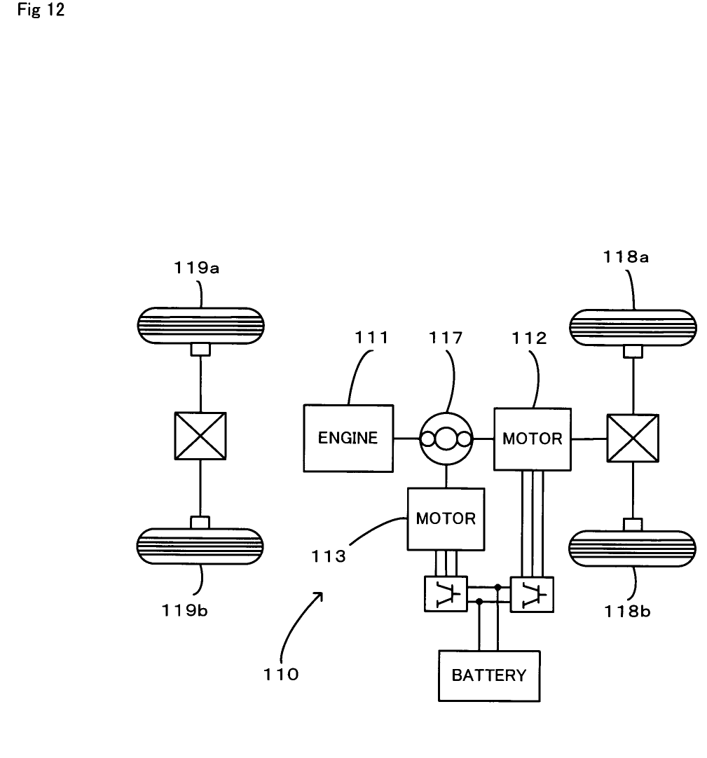

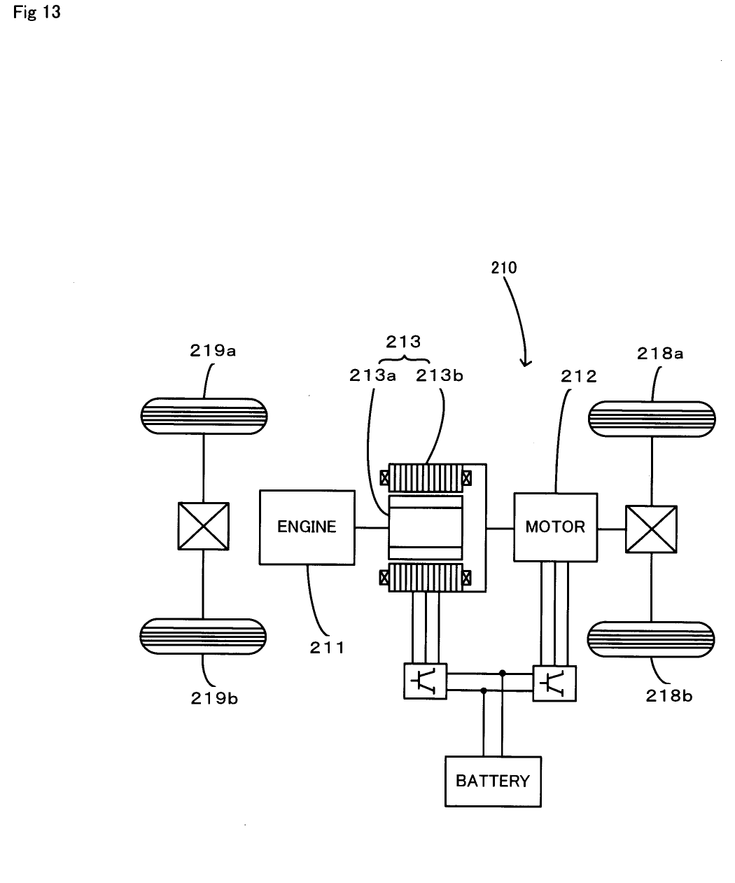

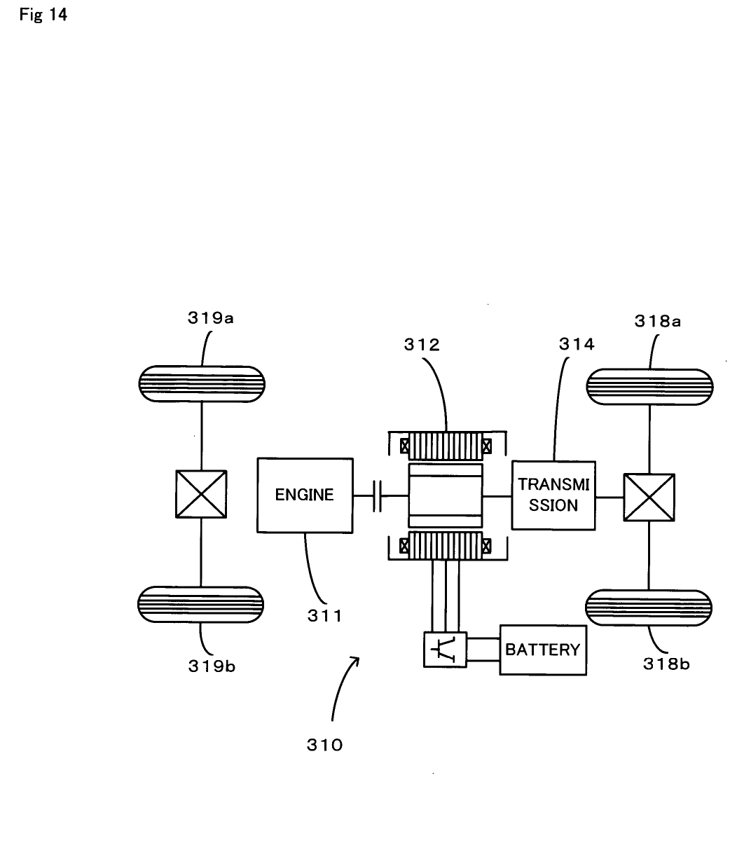

The embodiment described above regards control of the motor 12, which is mounted on the electric vehicle 10 and is mechanically connected with the drive shaft linked to the drive wheels 18a and 18b to directly output power to the drive shaft. The technique of the invention is applicable to a vehicle of any other structure with a motor that is capable of directly outputting power to a drive shaft or an axle. For example, one possible application of the invention is a series hybrid vehicle including an engine, a generator that is linked to an output shaft of the engine, a battery that is charged with electric power generated by the generator, and a motor that is mechanically connected with a drive shaft linked to drive wheels and is driven with a supply of electric power from the battery. In this structure, the motor may be attached to the axle instead of to the drive shaft, or may otherwise be attached directly to the drive wheels, for example, as in-wheel motors. Another possible application of the invention is a mechanical distribution-type hybrid vehicle 110 including an engine 111, a planetary gear 117 that is connected with the engine 111, a motor 113 that is connected with the planetary gear 117 and is capable of generating electric power, and a motor 112 that is also connected with the planetary gear 117 and is mechanically connected with a drive shaft linked to drive wheels to directly output power to the drive shaft, as shown in FIG. 12. Still another possible application of the invention is an electrical distribution-type hybrid vehicle 210 including a motor 213 that has an inner rotor 213a connected with an output shaft of an engine 211 and an outer rotor 213b connected with a drive shaft linked to drive wheels 218a and 218b and relatively rotates through electromagnetic interactions between the inner rotor 213a and the outer rotor 213b and a motor 212 that is mechanically connected with the drive shaft to directly output power to the drive shaft, as shown in FIG. 13. Another possible application of the invention is a hybrid vehicle 310 including an engine 311 that is connected with a drive shaft linked to drive wheels 318a and 318b via a transmission 314 (for example, a continuous variable transmission or an automatic transmission) and a motor 312 that is placed after the engine 311 and is connected with the drive shaft via the transmission 314 (or a motor that is directly connected with the drive shaft), as shown in FIG. 14. In the event of the occurrence of a skid on drive wheels, the torque control mainly controls the motor mechanically connected with the drive shaft, because of its high torque output response. The control of this motor may be combined with control of the other motor or with control of the engine.

The embodiment described above regards one modification of a control apparatus 20 functioning as a road surface condition change estimation apparatus that estimates a change of a road surface condition in the vehicle driving state. Another modification may be a road surface condition change estimation method that estimates a change of a road surface condition in the vehicle driving state.

The embodiment and its modified examples discussed above are to be considered in all aspects as illustrative and not restrictive. There may be many other modifications, changes, and alterations without departing from the scope or spirit of the main characteristics of the present invention.

### INDUSTRIAL APPLICABILITY

The technique of the invention is effectively applied to automobile-related industries.

1. (canceled)

2. A road surface condition change estimation apparatus that is mounted on an automobile and estimates a change in condition of a road surface where said automobile runs, said road surface condition change estimation apparatus comprising:
a rotation angular acceleration measurement module that measures a rotation angular acceleration of a drive shaft, which is mechanically linked to drive wheels of said automobile; and
a condition change estimation module that estimates the change of the road surface condition, based on a variation in period of a time change of the measured rotation angular acceleration that increases to or over a predetermined reference value.

3. A road surface condition change estimation apparatus in accordance with claim 2, wherein said condition change estimation module estimates the change of the road surface condition, in response to a variation in period of a time change of the measured rotation angular acceleration at or over a predetermined rate.

4. A road surface condition change estimation apparatus in accordance with claim 3, wherein said condition change estimation module estimates an abrupt increase in friction coefficient on the road surface, when the period of the time change of the measured rotation angular acceleration in an opposite peak detected immediately after a first peak, which appears after an increase of the rotation angular acceleration to or over a predetermined reference value, is shorter than the period of the time change in the first peak by or over the predetermined rate.

5. A road surface condition change estimation apparatus in accordance with claim 2, wherein said condition change estimation module estimates the change of the road surface condition, based on a first peak value detected after an increase of the measured rotation angular acceleration to or over a predetermined reference value and an opposite second peak value detected immediately after the first peak value.

6. A road surface condition change estimation apparatus in accordance with claim 5, wherein said condition change estimation module estimates the change of the road surface condition, in response to a variation of an absolute value of the second peak value relative to an absolute value of the first peak value by or over a predetermined rate.

7. A road surface condition change estimation apparatus in accordance with claim 6, wherein said condition change estimation module estimates an abrupt increase in friction coefficient on the road surface, when the absolute value of the second peak value is greater than the absolute value of the first peak value by or over the predetermined rate.

8. A road surface condition change estimation apparatus in accordance with claim 2, wherein said condition change estimation module estimates the change of the road surface condition, based on a second peak value of the measured rotation angular acceleration detected after an increase to or over a predetermined reference value.

9. A road surface condition change estimation apparatus in accordance with claim 8, wherein said condition change estimation module estimates an abrupt increase in friction coefficient on the road surface, when an absolute value of the second peak value is not less than a preset level.

10. An automobile, comprising:
a motor that outputs power to a drive shaft, which is mechanically linked to drive wheels of said automobile;
a rotation angular acceleration measurement module that measures a rotation angular acceleration of the drive shaft;
a condition change estimation module that estimates a change of a road surface condition corresponding to a variation in measured rotation angular acceleration; and
a drive control module that drives and controls said motor to regulate a torque level output to the drive shaft according to a driver's operation and a vehicle driving state, while driving and controlling said motor in response to estimation of the change of the road surface condition by said condition change estimation module, to restrict the torque level output to the drive shaft for a preset time period.

11. An automobile in accordance with claim 10, wherein said drive control module drives and controls said motor in response to estimation of the change of the road surface condition by said condition change estimation module, to restrict the torque level output to the drive shaft to a torque limit value, which is set corresponding to a peak value of the rotation angular acceleration measured by said rotation angular acceleration measurement module.

12. An automobile in accordance with claim 11, wherein said condition change estimation module estimates the change of the road surface condition, in response to a variation in period of a time change of the measured rotation angular acceleration that increases to or over a predetermined reference value at or over a predetermined rate.

13. An automobile in accordance with claim 11, wherein said condition change estimation module estimates the change of the road surface condition, in response to a variation of an absolute value of an opposite second peak value detected immediately after a first peak value relative to an absolute value of the first peak value detected after an increase of the measured rotation angular acceleration to or over a predetermined reference value by or over a predetermined rate.

14. An automobile in accordance with claim 11, wherein said condition change estimation module estimates the change of the road surface condition, when an absolute value of a second peak value of the measured rotation angular acceleration detected after an increase to or over a predetermined reference value is not less than a preset level.

15. A road surface condition change estimation method that estimates a change in condition of a road surface where said automobile runs, said road surface condition change estimation method comprising the steps of:
(a) measuring a rotation angular acceleration of a drive shaft, which is mechanically linked to drive wheels of said automobile; and
(b) estimating a change of a road surface condition, in response to a variation in period of a time change of the measured rotation angular acceleration that increases to or over a predetermined reference value at or over a predetermined rate.

16. A road surface condition change estimation method that estimates a change in condition of a road surface where said automobile runs, said road surface condition change estimation method comprising the steps of:
(a) measuring a rotation angular acceleration of a drive shaft, which is mechanically linked to drive wheels of said automobile; and
(b) estimating a change of a road surface condition, in response to a variation of an absolute value of an opposite second peak value detected immediately after a first peak value relative to an absolute value of the first peak value detected after an increase of the measured rotation angular acceleration to or over a predetermined reference value by or over a predetermined rate.

17. A road surface condition change estimation method that estimates a change in condition of a road surface where said automobile runs, said road surface condition change estimation method comprising the steps of:
(a) measuring a rotation angular acceleration of a drive shaft, which is mechanically linked to drive wheels of said automobile; and
(b) estimating a change of a road surface condition, when an absolute value of a second peak value of the measured rotation angular acceleration detected after an increase to or over a predetermined reference value is not less than a preset level.
